(19) United States
(12) Patent Application Publication
(10) Pub. No.: US 2010/0072191 A1
(43) Pub. Date: Mar. 25, 2010

(54) COOLING DEVICE FOR ELECTROMAGNETIC INDUCTION TYPE COOKIN HEATER

(76) Inventor: Yasuhiko Ookuma, Fukuoka (JP)

Correspondence Address: WENDEROTH, LIND & PONACK, L.L.P., 1030 15th Street, N.W.,, Suite 400 East, Washington, DC, 20005-1503, US

(21) Appl. No.: 12/448,017

(22) PCT Filed: Dec. 5, 2006
(86) PCT No.: PCT/JP2006/324271

§ 371 Date: Jun. 4, 2009

(51) Int. Cl. F25B 21/02; H05B 6/12

(52) U.S. Cl. 219/632; 62/3.2; 219/621

(57) ABSTRACT

It is an object of the present invention to provide a light and compact cooling device which is possible to use an alternating magnetic field generated in an electromagnetic induction type cooking heater which is usually used as a heater, as an energy source of the cooling device. The cooling device to be mounted on a plate of an electromagnetic induction type cooking heater including a coil by which a magnetic field is generated, the cooling device including a plurality of Peltier devices comprised of two kinds of metals or semiconductors, Peltier devices comprised of the first kind of metal or semiconductor and Peltier devices comprised of the second kind of metal or semiconductor being alternately arranged, the Peltier devices being electrically connected in series to one another through electrode plates (3, 4) to define a Peltier module A so that heat-absorption sides thereof are on the same side and heat-production sides thereof are on the other side, an electrical conductor (8) and a rectifying diode (7) being electrically connected to the electrode plates (3, 4) situated at the opposite ends of the Peltier module A.

### FIELD OF THE INVENTION

The invention relates to technology for using Peltier devices as a cooler by virtue of an induced current generated by a high-frequency induction magnetic field, which is a principle for generating heat in an electromagnetic induction type cooking heater (IH cooking heater).

### BACKGROUND ART

Recently, an electromagnetic induction type cooking heaters are broadly used as a highly safe cooking devices, because they do not use a flame, and do not possibly cause monoxide gas poisoning compared with cooking devices using gas.

In an electromagnetic induction type cooking heater, a coil which will generate a magnetic field is positioned beneath a plate composed of an electrically insulating material. Causing high-frequency waves (having a wavelength in a GHz order) to flow through the coil, there an alternate-current magnetic field is generated, and thus, eddy currents are induced in a metal (for instance, iron) pan put on the plate. As a result, there Joule's heat is generated in accordance with resistance of the metal of which the pan is composed, and hence, the pan is heated. The electromagnetic induction type cooking heater operates on the basis that a pan itself is heated by virtue of induced eddy currents.

The patent reference 1 suggests a cooking device which can heat and cool a food. The cooking device is designed to have an upper portion projecting from an upper surface of a body to place food thereon, and to include a temperature controller to carry out heat exchange between the food and the cooking device to thereby heat and cool the food. The cooking device heats and cools a food by causing a direct current to flow into Peltier devices. However, Peltier devices merely have a capacity to heat food at such a temperature that the food is kept at about 100 degrees centigrade. Accordingly, Peltier devices are not suitable for frying foods because it is necessary to heat a food at a high temperature for frying the food, and thus, it is necessary to prepare an electromagnetic induction type cooking heater as another device for frying foods.

The patent reference 2 suggests a heating/cooling device including a heater having a heating plate to be induction-heated by a heating coil, and a Peltier module chamber having a Peltier module comprised of Peltier devices for cooling a food.

The patent reference 3 suggests a food warmer which covers a food therewith to thereby warm the food. The food warmer includes an electronic cooler comprised of Peltier devices, and positioned at a summit of a cover having an outer surface composed of a high heat-insulating material and an inner surface composed of a high heat-conductive material, for cooling what is included in the cover.

### Patent Reference 1: Japanese Patent Application Publication 2004-335447

### Patent Reference 2: Japanese Patent Application Publication 2003-148850

### Patent Reference 3: Japanese Patent Application Publication 11-276358

### DISCLOSURE OF THE INVENTION

### Problems to be Solved by the Invention

Recently, cooking devices to be used in households are turning to be electric appliances together with life style being varied, and tastes for household cooking are changing remarkably. With propagation of an electromagnetic induction type cooking heater, various cooking processes are carried out. In some cooking processes, the food is cooled after first heating. Thus, there is a need for cooking devices which can not only heat a food, but also cool a food.

An existing electromagnetic induction type cooking heater is usually fixed in a kitchen, or used on a plate. Thus, if a food needs to be cooled, it is necessary to prepare ice or a cold insulator having been cooled in advance in a refrigerator, resulting in time consumption in preparation and clean up. A presently available cooking device is able to heat a food together with a gas cooking device, an electromagnetic induction type cooking heater and so on, but is not suitable for cooling a food.

As cooking tools which are able to cool a food, we can find some as suggested in the above-mentioned patent references 1 to 3, and as a cooking tool which is able to both heat and cool a food, we can find one as suggested in the patent reference 1. However, as mentioned earlier, Peltier devices for heating and cooling a food in the patent reference 1 cannot present a high temperature for heating a food for cooking. Accordingly, it is additionally necessary to prepare an electromagnetic induction type device, and Peltier devices and the electromagnetic induction type device are alternately and inconveniently operated depending upon whether a food is to be heated or cooled.

Furthermore, since every household already has some cooking devices, if a function of cooling a food were necessary, every household would have to reform an existing electromagnetic induction type cooking heater, or newly purchase the cooking device as suggested in the patent reference 1.

However, presently available electromagnetic induction type cooking heaters are all expensive, and an electromagnetic induction type cooking heater having a function of cooling foods, such as the one suggested in patent reference 1, is expected to be even more expensive. Thus, it is not practical to exchange a presently used device into the above-mentioned device for carrying out a certain cooking process which is usually carried out at a low frequency, except newly purchasing the above-mentioned device.

Since the cooling devices as suggested in the patent references 2 and 3 cover a food therewith, it is not possible to cool a food while cooking the same.

Furthermore, since the cooling devices suggested in the patent references 1 to 3 are designed to necessarily have a commercial electric-power source as an energy source for activating Peltier devices comprising the cooling devices, and to control the temperature by means of a temperature controller equipped therein, the cooling devices are unavoidably complex in structure because they have to include a circuit for controlling the temperature, resulting in such problems as, they are expensive, they cannot be compact, they are heavy, they are difficult to carry, and they unavoidably have obstructive codes. Thus, the cooling devices are not broadly used.

It is an object of the present invention to provide a light and compact cooling device which is capable of cooling a food while cooking the same without using a commercial electric-power source merely by putting the cooling device on a plate of a turned-on electromagnetic induction type cooking heater, and an electromagnetic induction type cooking heater which can be used not only as a heater, but also as a cooler without newly purchasing the same in place of an existing electromagnetic induction type cooking heater used as a heater in each household.

### Solution to the Problems

In order to achieve the above-mentioned object, the present invention provides, in a first aspect, a cooling device to be mounted on a plate of an electromagnetic induction type cooking heater including a coil by which a magnetic field is generated, wherein an energy source of the cooling device is presented from an alternating magnetic field generated in the electromagnetic induction type cooking heater.

In the first aspect, an alternating magnetic field generated by the magnetic field generating coil of the electromagnetic induction type cooking heater is used as an energy source for activating the cooling device. Thus, it is no longer necessary to use an external power source for activating the cooling device, and it is no longer necessary for the cooling device to include a wire to be electrically connected to a commercial electric-power source.

In a second aspect of the present invention, the cooling device is designed to include Peltier devices comprised of two kinds of metals or semiconductors. The second aspect makes it possible to achieve a cooling device eliminating the need for a power source.

In a third aspect of the present invention, the cooling device further includes an electrical conductor and a rectifying diode both defining a closed-loop circuit together with the Peltier devices to provide a direct current as an energy source to the Peltier devices.

In the third aspect, an alternating magnetic field generated by the magnetic field generating coil of the electromagnetic induction type cooking heater is received in the closed-loop circuit, and then, is converted into a direct current through the rectifying diode. The direct current is introduced into Peltier devices, resulting in the heat-absorption sides of Peltier devices being cooled. The contents of a pan or a container having a flat bottom that is placed on the heat-absorption sides of Peltier devices, what is contained in the pan or container is cooled.

The present invention provides, in a fourth aspect, a cooling device to be mounted on a plate of an electromagnetic induction type cooking heater including a coil by which a magnetic field is generated, the cooling device including a plurality of Peltier devices comprised of two kinds of metals or semiconductors, Peltier devices comprised of the first kind of metal or semiconductor and Peltier devices comprised of the second kind of metal or semiconductor being alternately arranged, the Peltier devices being electrically connected in series to one another through electrode plates to define a Peltier module such that heat-absorption sides thereof are on the same side and heat-production sides thereof are on the other side, an electrical conductor and a rectifying diode being electrically connected to the electrode plates situated at the opposite ends of the Peltier module.

In the fourth aspect, the Peltier module is defined by arranging a plurality of Peltier devices in such a way as mentioned above, ensuring a broad area for cooling a food. Furthermore, since a plurality of Peltier devices is arranged to define a part of a loop, it is possible to enhance an efficiency for cooling a food.

The cooling device in accordance with a fifth aspect of the present invention is designed to further include, in comparison with the fourth aspect, a coil interlinking with an alternating magnetic field generated in the coil by which a magnetic field is generated is electrically connected the opposite ends of the Peltier module through the electrical conductor and the rectifying diode.

Thus, a magnetic field generated by the magnetic-field generating coil is amplified in accordance with a number of turns of the coil, and accordingly, since a current running through the Peltier module can be made higher in an amount, it is possible to enhance performance of cooling a food.

In a sixth aspect of the present invention, the cooling device further includes a cooler for cooling the Peltier module at its heat-production side.

This ensures that it is possible to prevent the temperature at the heat-absorption sides from being lowered at a degree at which a temperature at the heat-production sides is lowered by cooling, and further prevent the temperature at the heat-absorption sides from being raised due to raising of the temperature at the heat-production sides, to thereby prevent the declining efficiency of cooling a food. Thus, a highly practicable cooling device to be used for electromagnetic induction type cooking heater can be archived.

### ADVANTAGES PROVIDED BY THE INVENTION

The present invention provides a cooling device to be mounted on a plate of an electromagnetic induction type cooking heater including a coil by which a magnetic field is generated, wherein an energy source of the cooling device is presented from an alternating magnetic field generated in the electromagnetic induction type cooking heater. Thus, it is possible to use an alternating magnetic field generated in an electromagnetic induction type cooking heater which is usually used as a heater, as an energy source of the cooling device. Hence, it is possible to use the electromagnetic induction type cooking heater not only as a heater, but also as a power source for a cooling device. Furthermore, since a temperature control in the cooling device can be accomplished by an intensity control of an alternating magnetic field generated in the electromagnetic induction type cooking heater, it is not necessary for the cooling device to include a complex control circuit.

### BRIEF DESCRIPTION OF THE DRAWINGS

FIG. 1 shows the principle of a Peltier module making use of Peltier effect.

FIG. 2 shows the principle of an electromagnetic induction type cooking heater.

FIG. 3A is a cross-sectional view of the Peltier module in accordance with the embodiment of the present invention.

FIG. 3B is a plan view of the Peltier module in accordance with the embodiment of the present invention.

FIG. 4 shows the principle of the operation of the first embodiment.

FIG. 5 shows the principle of the operation of the second embodiment.

FIG. 6 is a circuit diagram illustrating an example for feeding electric power to the Peltier module operating in accordance with the principle of the second embodiment.

FIG. 7 is a circuit diagram illustrating another example for feeding electric power to the Peltier module operating in accordance with the principle of the second embodiment.

FIG. 8 is a cross-sectional view of a specific example of cooling device in accordance with the present invention, to be used for an electromagnetic induction type cooking heater.

### INDICATION BY REFERENCE NUMERALS

1 P-type semiconductor
2 N-type semiconductor
3, 4 Electrode plate
5, 6 Ceramic plate
7 Diode
8 Electrical conductor
11 Top plate
12 Magnetic field generating coil
13 Pan

### BEST EMBODIMENT FOR REDUCING THE INVENTION TO PRACTICE

Embodiments in accordance with the present invention will be explained hereinbelow with reference to drawings.

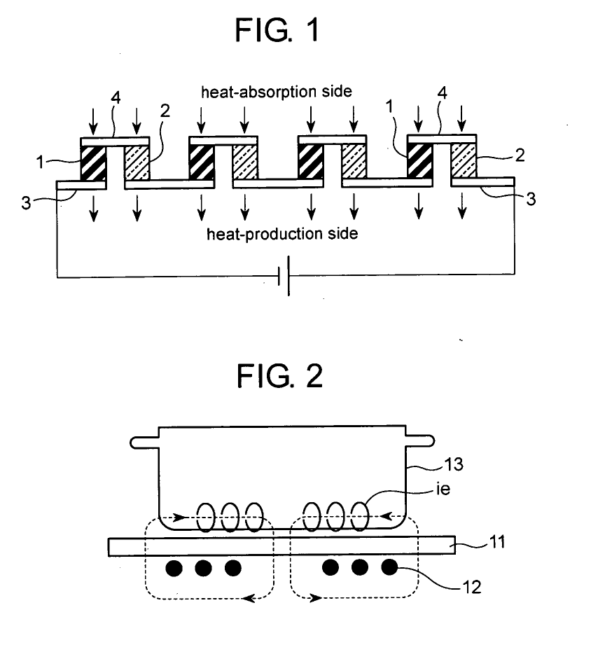

First, the Peltier effect is explained hereinbelow with reference to FIG. 1.

The Peltier effect is that if a current flow through a junction through which two metals or semiconductors, are joined with each other, heat transfers from one of the two metals or semiconductors to the other metal or semiconductor. A Peltier module is constructed as follows on the basis of this principle. As illustrated in FIG. 1, P-type semiconductors 1 and N-type semiconductors 2 are alternately arranged on a plane, and the semiconductors 1 and 2 are electrically connected in series through metal electrode plates 3 and 4 to thereby define a Peltier module. By causing a current to flow through the Peltier module, one of the electrode plates, for instance, the electrode plate 4 acts as a heat-absorption side, specifically, is cooled. The other electrode plate, that is, the electrode plate 3 acts as a heat-production side, specifically, is heated.

FIG. 2 shows a principle of an electromagnetic induction type cooking heater. A magnetic field generating coil 12 is positioned beneath a top plate 11 composed of heat-resistance glass. By causing a high-frequency current to run through the magnetic field generating coil 12, an alternating magnetic field is generated in the magnetic field generating coil 12. Putting an iron pan 13 on the top plate 11, eddy currents “ie” are induced at a bottom of the iron pan 13. Since the eddy currents run through a resistance of iron of which the pan 13 is composed, there Joule's heat is generated, resulting in the pan 13 being heated at the bottom thereof, and hence, the food contained in the pan 13 is heated.

In the present invention, a current generated in a closed-loop circuit defined on the top plate 11 due to an alternating magnetic field generated in the magnetic field generating coil 12 of the electromagnetic induction type cooking heater interlinks with the closed-loop circuit is used as a power source to thereby operate the Peltier module as a cooling device.

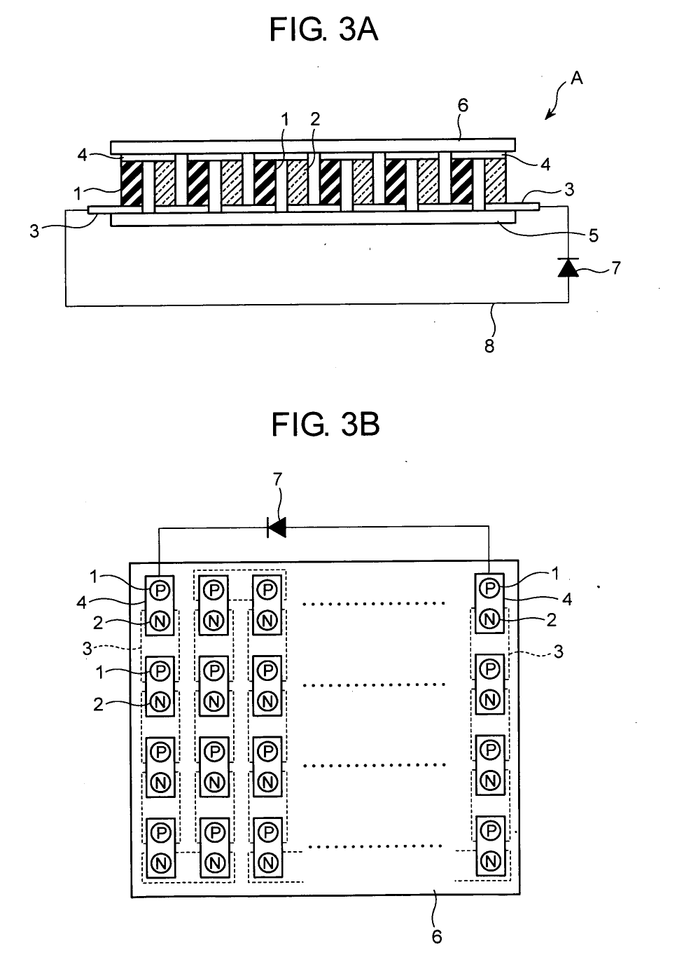

Specifically, as illustrated in FIGS. 3A and 3B, P-type semiconductors 1 and N-type semiconductors 2 are alternately arranged on a plane, and the semiconductors 1 and 2 are electrically connected in series through metal electrode plates 3 and 4 to thereby define an arrangement like a picture drawn with a single stroke of a brush. The semiconductors 1 and 2 may be arranged in a spiral. Ceramic plates 5 and 6 are adhered to the electrode plates 3 and 4 to thereby define a Peltier module. A. The electrode plates 3 disposed at the opposite ends are electrically connected to each other by electrical conductor 8 through a diode 7, to thereby define a closed-loop circuit.

In the above-mentioned structure, an alternating magnetic field generated in the magnetic field generating coil 12 of the electromagnetic induction type cooking heater is introduced into the closed-loop circuit defined by the Peltier module “A” and the electrical conductor 8, and is rectified by the diode 7. Thus, a current running toward a single direction, that is, a direct current runs through the Peltier module “A”, and resultingly, heat accumulated in the ceramic plate 6 is absorbed. As a result, putting a pan (preferably, composed of an electrical insulator such as glass) on the ceramic plate 6, what is contained in the pan is cooled. Since the other ceramic plate, that is, the ceramic plate 5 acts as a heat-production side, it is possible to enhance the cooling efficiency by causing the ceramic plate 5 to make contact with a cooling medium circulated in a radiator (mentioned later) to thereby cool the ceramic plate 5.

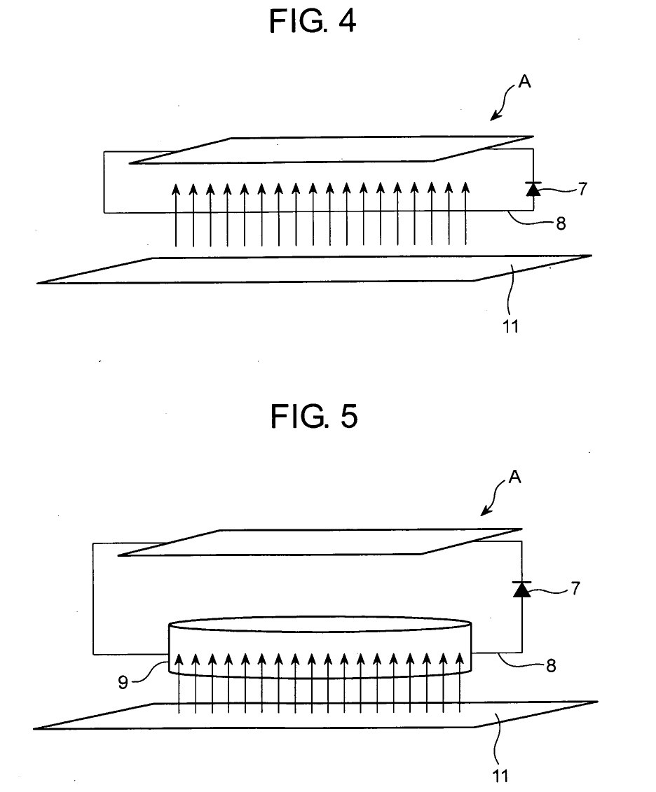

Then, the principle of the operation of the first embodiment in accordance with the present invention is explained hereinbelow with reference to FIG. 4. Putting the Peltier module “A” on the top plate 11 of an electromagnetic induction type cooking heater, there is generated an alternating magnetic field perpendicularly to the magnetic field generating coil 12 by virtue of a high-frequency current running through the magnetic field generating coil 12 (see FIG. 2) disposed beneath the top plate 11. The alternating magnetic field induces a current into a closed-loop circuit defined by the Peltier module “A”, the diode 7 and the electrical conductor 8. The current is rectified by the diode 7, and thus, the current runs through the P-type semiconductors 1 and the N-type semiconductors 2 defining Peltier devices in the Peltier module “A”, in a single direction, and resultingly, the Peltier module is cooled at a surface thereof. Putting a pan or container on the Peltier module “A”, a food contained in the pan or container is rapidly cooled.

Then, the principle of the operation of the second embodiment in accordance with the present invention is explained hereinbelow with reference with FIG. 5. In the second embodiment, a coil 9 is disposed under the Peltier module “A”. The coil 9 and the Peltier module “A” are electrically connected to each other through an electrical conductor 8 and a diode 7. Whereas the closed-loop circuit disposed outside of the Peltier module “A” has a single turn, the coil 9 in the second embodiment is designed to have a plurality of turns, ensuring that a magnetic field generated in the magnetic field generating coil 12 (see FIG. 2) can have a great number of interlinkages, and hence, an induced electromotive force can be amplified. This is based on that as if transformers connected to each other through an alternating magnetic field exist across the magnetic field generating coil 12 and the coil 9. Thus, the Peltier module “A” provides a high cooling efficiency, and high practicability.

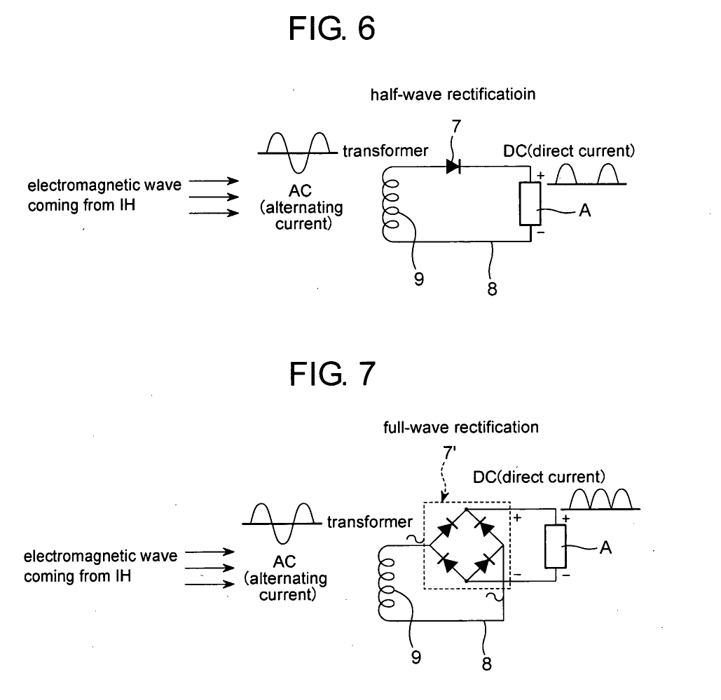

If the single rectifying diode 7 was arranged between the Peltier module “A” and the coil 9, a current running through the Peltier module “A” would have a rectified half-wave waveform, as illustrated in FIG. 6. Accordingly, since an average current is a half of a full wave resulting in low efficiency. Thus, as illustrated in FIG. 7, if a diode bridge A' were used in place of the single diode 7, a current having a rectified full-wave waveform runs through the Peltier module “A”, and accordingly, it would be possible to allow a current to run through the Peltier module in an amount twice greater than an amount of a current running through the Peltier module to which the single diode 7 is electrically connected. Thus, there can be obtained enhanced cooling performance.

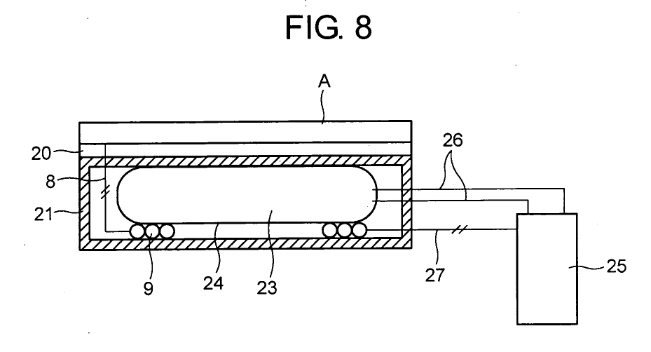

In the explanation having been made above, the electrode plate 4 of the Peltier module “A” is cooled. In a Peltier device, one side is cooled and the other side is heated due to heat transfer. Accordingly, the electrode plate 3 situated oppositely to the electrode plate 4 is heated. Thus, heat produced at the electrode plate 3 may transfer to the cooled electrode plate 4, and resultingly, the electrode plate 4 may not be cooled beyond a certain temperature. To avoid this, as illustrated in FIG. 8, a radiator may be connected to the Peltier module.

In FIG. 8, a radiating plate 20 composed of a non-magnetic material such as aluminum is attached to a lower surface of the Peltier module “A”, and the radiating plate 20 is fixed on an upper surface of a case 21 composed of a non-metal material such as plastic. A coil 9 having a plurality of turns and a container 24 containing therein a coolant 23 such as water are arranged on an inner bottom of the case 21 such that they are situated in the vicinity of the top plate 11 of the electromagnetic induction type cooking heater. A radiator 25 is disposed outside of the case 21. The radiator 25 radiates heats contained in the coolant 23, through a circulation pipe 26. A cooling fan (not illustrated) of the radiator 25 may be driven by introducing a high-frequency current induced in the coil 9, thereinto through a wire 27.

By arranging the radiator 25 and the circulation pipe 26 in the case 21, it is possible to reduce the space in which they are to be arranged, in which case, a user is relieved from the work of arranging the radiator 25 and the circulation pipe 26 around the case 21 each time the cooling device is used.

One or more commercially available Peltier module(s) “A” may be used. For instance, if twelve Peltier modules were used, each having a specification of 12V, 6 Amax, and 57 W of maximum heat absorption, total power consumption would be 864 W, which can be provided by a high-frequency magnetic field generated in an electromagnetic induction type cooking heater having output power in the range of 600 to 800 W (a general electromagnetic induction type cooking heater has output power of 1000 W or smaller).

The maximum temperature among temperatures at which the Peltier module “A” can be used is 150 degrees centigrade which is below the temperature at which solder is melted. Accordingly, if water cooling were selected, a temperature of the Peltier module would not be safely over 100 degrees centigrade. If the heat-production side were at 50 degrees centigrade, the heat-absorption side would be calculated to be at −22 degrees centigrade, ensuring sufficient cooling performance.

As mentioned above, by cooling the heat-production sides of the Peltier devices, it would be possible to lower a temperature of the heat-absorption sides.

In the above-mentioned embodiments, the Peltier module is put on a plate of the electromagnetic induction type cooking heater, and what is contained in a pan or a container put on the Peltier module is cooled. Variations may be made to the embodiments as follows.

1. By changing a polarity of the diode, an upper side of the Peltier module may be used as a heat-production side. In an electromagnetic induction type cooking heater, if a pan to be placed thereon is composed of a metal having a certain electrical resistance, such as iron, heat would be produced based on Joule's heat caused by eddy currents. This means that a pan or a container composed of an electrical insulating material such as glass would not produce heat even if mounted on an electromagnetic induction type cooking heater. By using the upper surface of the Peltier module as a heat-production surface, it is possible to heat a pan mounted thereon, even if the pan is composed of glass. This indicates that though a glass pan could not be used together with an electromagnetic induction type cooking heater, the present invention makes it possible to use a glass pan together with an electromagnetic induction type cooking heater. Furthermore, an electromagnetic induction type cooking heater is used for heating a food, and is not suitable for keeping a food warm. Thus, even if the temperature to be achieved in an electromagnetic induction type cooking heater were set to be low, the cooking heater would provide a temperature achieved by “a low flame”, resulting in the food contained in a pan mounted on an electromagnetic induction type cooking heater for a long time, might be scorched. In contrast, in accordance with the present invention, by using an upper surface of the Peltier module as a heat-production surface, it is possible to keep food warm at a low temperature, ensuring that the food can be heated for a long time to such a degree as to prevent the food from becoming cool.

2. The Peltier module in accordance with the above-mentioned embodiments may be formed integral with the bottom of a pan. Thus a cooling pan to be used only for an electronmagnetic induction type cooking heater is achieved.

3. The electronmagnetic induction type cooking heater may be used as a cooling device in a food supplier (for instance, a Japanese-“okonomiyaki” (grill) shop, an inn or a restaurant) in which an electronmagnetic induction type cooking heater is used as a heat source for heating a food on a table.

For instance, when cooled sweets such as icecream, sherbet or pudding are served after dinner, the electronmagnetic induction type cooking heater may be used to prevent them from melting or prevent the temperature from rising.

Furthermore, when “sashimi” (raw fish) is first served at a party, the cooling device in accordance with the present invention may be used to keep them fresh, and after eating “sashimi”, the electronmagnetic induction type cooking heater may be used to grill a food by means of a heating function thereof.

In a restaurant such as a rotary-type “sushi” restaurant, a magnetic-force generating coil may be arranged beneath a conveyer, and a dish or a tray into which the Peltier module is embedded in a bottom thereof may be transferred by putting them on the conveyer, in which case, it is possible to cool “sushi” or a food to thereby keep them fresh while they are being transferred. A food which is not to be cooled may be put on a dish in which the Peltier module is not embedded.

### INDUSTRIAL APPLICABILITY

The present invention is suitable to kitchen devices to be used in households or in business by using a Peltier device or Peltier devices as a cooling device, making use of an induced current caused by high-frequency induced magnetic field, which is the principle of producing heat in the electromagnetic induction type cooking heater.

1. (canceled)

2. (canceled)

3. (canceled)

4. A cooling device to be mounted on a plate of an electromagnetic induction type cooking heater including a coil by which a magnetic force is generated,
said cooling device including a plurality of Peltier devices comprised of two kinds of metals or semiconductors, Peltier devices comprised of the first kind of metal or semiconductor and Peltier devices comprised of the second kind of metal or semiconductor being alternately arranged,
said Peltier devices being electrically connected in series to one another through electrode plates to define a Peltier module so that heat-absorption sides thereof are on the same side and heat-production sides thereof are on the other side,
an electrical conductor and a rectifying diode being electrically connected to the electrode plates situated at the opposite ends of said Peltier module.

5. The cooling device as set forth in claim 4, further comprising a coil interlinking with an alternating magnetic field generated in said coil by which a magnetic force is generated is electrically connected said opposite ends of said Peltier module through said electrical conductor and said rectifying diode.

6. The cooling device as set forth in claim 4, further comprising a cooler for cooling said Peltier module at its heat-production side.

7. The cooling device as set forth in claim 6, wherein said cooler is comprised of a heat-radiating plate attached to a heat-production side of said Peltier module, a case composed of a non-metal material, said heat-radiating plate being attached to an upper surface of said case, a coil arranged on a bottom of said case in said case, a container containing therein a coolant and arranged in said case, and a radiator circulating said colorant for cooling the same.

8. The cooling device as set forth in claim 5, further comprising a cooler for cooling said Peltier module at its heat-production side.
